(19) United States
(12) Patent Application Publication
(10) Pub. No.: US 2002/0190197 A1
(43) Pub. Date: Dec. 19, 2002

(54) Photodetection device

(76) Inventors: Jun Sasagawa, Tokyo-to (JP); Hirokazu Yamada, Tokyo-to (JP); Hiroto Shibuya, Tokyo-to (JP); Yoshiyuki Usami, Tokyo-to (JP)

Correspondence Address: Kevin S. Lemack, Nields & Lemack, 176 E. Main Street, Westboro, MA, 01581, US

(21) Appl. No.: 10/170,598

(22) Filed: Jun. 13, 2002

(30) Foreign Application Priority Data
Jun. 19, 2001 (JP) JP2001-185665

(51) Int. Cl. H01J 5/02

(52) U.S. Cl. 250/239

(57) ABSTRACT

A photodetection device for accommodating photodetection elements and for detecting a photodetecting position, comprising a base, a transparent cylindrical case fixed on the base and having a closed upper end, guide grooves formed with the case, and substrates with electronic components, wherein the substrates are engaged and held in the guide grooves.

### BACKGROUND OF THE INVENTION

The present invention relates to a photodetection device to be used in a construction machine control system for civil engineering work such as ground leveling work by utilizing a laser reference plane formed by rotary irradiation of a laser beam.

First, brief description will be given below on a construction machine control system utilizing a laser reference plane by referring to FIG. 7.

In FIG. 7, reference numeral 1 denotes a rotary laser irradiating system, and 2 represents a bulldozer. The rotary laser irradiating system 1 is placed at an adequate position on a housing development area using a tripod 3. The rotary laser irradiating system 1 projects a laser beam 4 in a horizontal direction and rotates the laser beam, and a horizontal reference plane is formed by the laser beam 4.

The bulldozer 2 has a blade 5 supported in such manner that the blade 5 can be moved up and down. A pole 6 is erected on the blade 5, and a photodetection device 7 is mounted on the pole 6.

The pole 6 comprises a lift mechanism, which contains a motor, a screw, nut, etc. incorporated in the lift mechanism, and the photodetection device 7 can be moved in upward and downward directions. The photodetection device 7 receives the laser beam 4 from the rotary laser irradiating system 1 and detects a photodetecting position. The bulldozer 2 is provided with a control unit (not shown), which detects a height position of the blade 5 based on a photodetection signal from the photodetection device 7, which drives a hydraulic cylinder 8 according to the result of the detection, and which controls the height of the blade 5 is controlled.

As described above, when the horizontal reference plane is formed by the laser beam 4, by maintaining a distance between the horizontal reference plane and a blade edge 5a of the blade 5 at a constant value, i.e. by controlling the hydraulic cylinder 8 so as to maintain the photodetecting position of the photodetection device 7 without changing the height of the photodetection device 7 by the pole 6, the ground can be leveled in a horizontal direction. Also, by driving the pole 6 and by changing positional relationship between the photodetection device 7 and the blade 5, and further, by driving the hydraulic cylinder 8 and by maintaining the photodetecting position at a reference photodetecting position, it is possible to change the position of the blade 5, i.e. the position of the blade edge 5a in a vertical direction, and also to change the height of the ground to be leveled.

For instance, when the photodetection device 7 is moved up by the pole 6 and the photodetecting position of the photodetection device 7 is maintained at the reference photodetecting position, the distance between the blade edge 5a and the horizontal reference plane is increased. As a result, the blade edge 5a is moved down, and the leveled ground surface is turned to a lower level than the reference plane for ground leveling.

The distance between the reference photodetecting position and the blade edge 5a can be controlled by detecting an amount of driving of the pole 6.

Because the construction machine is often moved to different places for operation, the photodetection device must be designed in such manner that the photodetection device can receive and detect the laser beams coming from all directions. When the construction machine is moved, it is subjected to high vibration and impact, and the photodetection device is also required to have sufficient strength.

Referring to FIG. 8 and FIG. 9, description will be given on a conventional type photodetection device 7.

Between a lower lid 10 and an upper lid 11 made of metal material, a transparent cylinder 12 made of plastic material is sandwiched. When seen from above, each of the lower lid 10, the upper lid 11, and the transparent cylinder 12 is in a flat hexagonal shape with a pair of longer sides and 2 pairs of shorter sides. On the lower lid 10, four rods 13 are erected. The lower end of each rod is fixed by a screw, and the upper end of each of the rods 13 is fixed on the upper lid 11 using a bolt 14.

Sealing members 15 and 15 made of rubber material are sandwiched between the lower lid 10 and the transparent cylinder 12 and between the upper lid 11 and the transparent cylinder 12, and a case comprising the lower lid 10, the upper lid 11, and the transparent cylinder 12 is water-tightly sealed.

On the rods 13, support plates 16 and 17 running in parallel to a plane including the longer side of the transparent cylinder 12 are fixed. On one support plate 16, circuit substrates 18 and 19 are mounted in two tiers. On the upper circuit substrate 19, eleven light emitting diodes are arranged, i.e. three diodes are arranged in a horizontal direction at the middle. The four light emitting diodes 21 are arranged symmetrically each of above and under the three light emitting diodes 21 . The four light emitting diodes 21 on upper side form V-shape which includes the middle one of the three light emitting diodes 21 as a vertex. The four light emitting diodes 21 arranged on lower side form inverted V-shape which includes the middle one of the three light emitting diodes 21 as a vertex.

A light-passing hole 22 is provided at a position to match the light emitting diode 21 of the support plate 17, and a tip of the light emitting diode 21 faces the light-passing hole 22.

At both ends of each of the support plate 16 and the support plate 17, sensor support members 23 are provided. On the sensor support member 23, a photodetection plate 24 running in parallel to a surface including the shorter side of the transparent cylinder 12 is arranged. On the photodetection plate 24, photodetection elements 25 are arranged linearly in a vertical direction.

Although not shown in the figure, a power source unit to accommodate a battery is provided on the lower side of the lower lid 10 and is connected via cable. This supplies electric power required for light emission of the light emitting diodes 21 and for operation of the circuit substrates 18 and 19.

Because the transparent cylinder 12 is transparent, the laser beam 4 can enter from all directions. Because the photodetection plates 24 are provided facing in 4 directions, the photodetection plates 24 can receive and detect the laser beams 4 coming from all directions. The photodetection elements 25 are arranged linearly in the vertical direction. By identifying the photodetection signal from the photodetection element 25 which receives and detects the light from a photodetection signal, the photodetecting position of the photodetection device 7 can be detected.

Based on the result of photodetection of the photodetection plate 24, the light emitting diodes 21 begin to flash, and a display pattern to match the photodetecting position is selected.

Display patterns of the conventional type device are shown in the upper column of FIG. 6.

In case the photodetecting position of the photodetection device 7 is considerably higher than the reference photodetecting position, the upper five light emitting diodes 21 in larger V-shaped arrangement begin to flash slowly. In case it is higher, the upper five light emitting diodes 21 in larger V-shaped arrangement are continuously lighted up. In case it is a little higher, the upper five light emitting diodes 21 in larger V-shaped arrangement begin to flash quickly. In case the photodetecting position is aligned with the reference photodetecting position, the three light emitting diodes 21 at a horizontal position begin to flash quickly.

In case the photodetecting position of the photodetection device 7 is a little lower than the reference photodetecting position, the lower five light emitting diodes 21 in larger inverted V-shaped arrangement begin to flash quickly. In case it is lower, the lower five light emitting diodes 21 in larger inverted V-shaped arrangement are lighted up continuously. In case it is considerably lower, the lower five light emitting diodes 21 in larger inverted V-shaped arrangement begin to flash slowly.

By watching the display patterns of the light emitting diodes 21, an operator can judge whether the current digging level is higher or lower than the reference position.

In the conventional type photodetection device 7 as described above, the lower lid 10, the transparent cylinder 12 and the upper lid 11, provided as separate components, are designed to be integrated by fastening them together by the rods 13. The rods 13 serve as fastening means, but not as reinforcing members. The transparent cylinder 12 serves as a reinforcing member, but the transparent cylinder 12 itself has low strength because it is made of plastic material. To integrate and consolidate the lower lid 10, the transparent cylinder 12 and the upper lid 11, fastening force of the rods 13 should be increased. However, the transparent cylinder 12 is made of plastic material, and the fastening force cannot be increased very much. To increase the strength of the transparent cylinder 12, thickness should be increased. However, this leads to the decrease of transmittance of the laser beam 4 and to the weight increase of the photodetection device 7. As a result, the strength of the pole 6 becomes an issue.

The upper end is the upper lid 11 made of metal. When the photodetection device 7 is subjected to vibration, the upper lid 11 may act as a vibrating weight and this may give heavy burden on the transparent cylinder 12.

Further, the photodetection plates 24 are supported by the rods 13 via the support plates 16. When vibration is applied on the photodetection device 7 from outside, the rods 13 themselves may be vibrated.

If consideration is given on the facts that vibration is strong, that the device is mounted on the blade 5 of the construction machine, and that it is supported by the pole 6, it is desirable that the photodetection device 7 is designed as lightweight as possible and to be highly resistant to vibration.

In the conventional type photodetection device 7, a number of light emitting diodes 21 are used to indicate the photodetecting position, and this leads to the problem of high power consumption.

### SUMMARY OF THE INVENTION

It is an object of the present invention to provide a photodetection device, which is lightweight in design, has high strength and can be operated with low power consumption.

To attain the above object, the present invention provides a photodetection device for accommodating photodetection elements and for detecting a photodetecting position, comprising a base, a transparent cylindrical case fixed on the base and having a closed upper end, guide grooves formed with the case, and substrates with electronic components, wherein the substrates are engaged and held in the guide grooves. Also, the present invention provides a photodetection device as described above, wherein a distance between groove bottoms of the guide grooves facing to each other and holding the substrates is increased from an upper end toward a lower end. Further, the present invention provides a photodetection device as described above, wherein the distance between the groove bottoms of the guide grooves for holding the substrates are widened in form of a trapezoid from the upper end toward the lower end, and a distance of draft of a molding die is reduced when the molding die is withdrawn from the lower end. Also, the present invention provides a photodetection device as described above, wherein a support to engage with a tip of the substrate is provided at a ceiling of the case, a support to engage with a base end of the substrate is provided on the base, and the substrate is held by the ceiling and the base. Further, the present invention provides a photodetection device as described above, wherein the substrate has its diameter reduced toward an upper end of the substrate. Also, the present invention provides a photodetection device as described above, wherein the substrate is provided in such manner that a closed cross-section is formed by the substrate and the case. Further, the present invention provides a photodetection device as described above, wherein the substrate is a photodetection sensor substrate where photodetection elements are arranged in a linear direction, three photodetection sensor substrates are arranged in three different directions, and a portion of the case facing to at least one of the photodetection sensor substrates is curved in form of a cylindrical surface. Also, the present invention provides a photodetection device as described above, wherein the photodetection device further comprises a light emitting element substrate where the light emitting elements are arranged, the case is designed in cylindrical shape with an approximately rectangular cross-section, the photodetection sensor substrates are arranged at three corners of the case, and the light emitting element substrate is provided in parallel to one surface of the case including a remaining corner. Further, the present invention provides a photodetection device as described above, wherein as many light emitting elements as required are arranged on the substrates, and status of photodetecting position is displayed in a combination of flashing light emission and alternate light-emission depending on the photodetecting position.

### BRIEF DESCRIPTION OF THE DRAWINGS

FIG. 1 is a front view showing an embodiment of the present invention;

FIG. 2 is a cross-sectional view of the embodiment of the present invention as seen from front side;

FIG. 3 is a cross-sectional view of the embodiment of the present invention as seen from above;

FIG. 4 is a drawing to explain how a photodetection device of the present embodiment is mounted;

FIG. 5 is a block diagram of a control circuit of the embodiment of the present invention;

FIG. 6 shows comparison of display patterns between the present embodiment and a conventional type device;

FIG. 7 is a drawing to explain a construction machine control system where the photodetection device is used;

FIG. 8 is a cross-sectional view of a conventional type device as seen from front side; and

FIG. 9 is a cross-sectional view of the conventional type device as seen from above.

### DETAILED DESCRIPTION OF THE PREFERRED EMBODIMENT

Description will be given below on an embodiment of the present invention referring to the drawings.

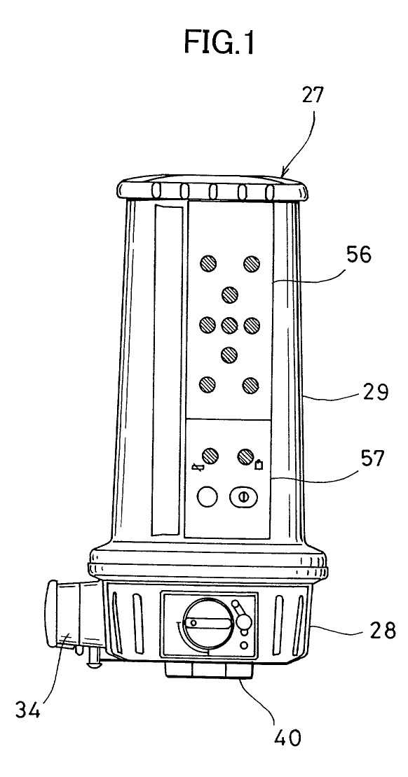

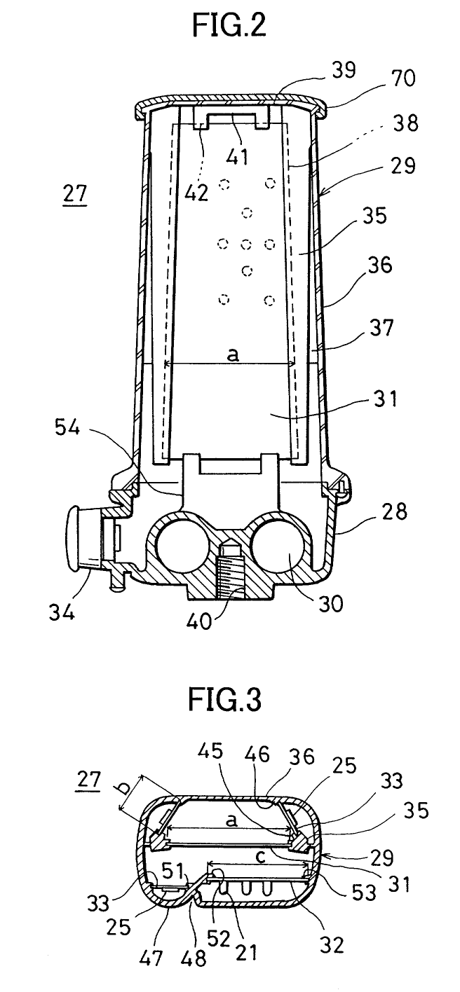

In FIG. 1, FIG. 2 and FIG. 3, reference numeral 27 denotes a photodetection device, 28 represents a base made of metal material, and 29 is a case made of transparent plastic material. At a tip of the case 29, a cap 70 made of rubber material is mounted. The base 28 is integrally molded with the case 29, and the case 29 is water-tightly mounted on the base 28 at its low end.

The base 28 serves as a power source unit where a battery 30 is accommodated, and the power source unit supplies electric power to a circuit substrate 31, a diode driving substrate 32, and a photodetection sensor substrate 33 as described later. The base 28 has a connector 34 for external connection and is connected to a pole 6 or to a control unit of a bulldozer 2. A screw 40 for fixing purpose is provided at the bottom of the base 28.

The case 29 is designed in a cylindrical shape with its diameter reduced toward the tip and has a closed upper end. In the cross-sectional view seen from above, the case 29 is approximately in rectangular form and is oblong in left-to-right direction.

On each side at left and right in the inner part of the case 29, substrate guides 35 are formed from the upper end to the lower end. The lowest part of each of the substrate guides 35 is integrated with a trunk 36 of the case 29 and has its diameter reduced toward the lower end. Each substrate guide 35 up to the middle portion is connected with the trunk 36 via a rib 37. Each substrate guide 35 is provided with a guide groove 38 where the circuit substrate 31 is inserted. The guide groove 38 has a width of approximately the same dimension from its base end to the lower end. A distance “a” between groove bottoms of the guide groove 38 and of the guide groove 38 facing to is increased in a downward direction.

The case 29 is made of plastic material and provided with draft, which is useful to withdraw it from a molding die. The substrate guide 35 itself is designed with its diameter reduced toward the lower end. Because the distance “a” between the groove bottoms of the guide grooves 38 is increased in form of a trapezoid toward the lower end, there is no need to have the draft to withdraw from the upper end to the lower end. Because the distance is short, the grooves have approximately the same width and the same depth. This makes it possible to exclude backlash of the circuit substrates 31 to be fixed. Also, this prevents the circuit substrates 31 from being damaged due to backlash.

On a ceiling 39 of the case 29, a substrate tip support 41 is provided, and the substrate tip support 41 has a groove 42, which is in the same plane as the guide groove 38.

The circuit substrate 31 is inserted between the guide grooves 38 and 38 from below. When the circuit substrate 31 is completely inserted, the upper end of the circuit substrate 31 is engaged with the grooves 42. Width of the circuit substrate 31 is decreased in an upward direction and the circuit substrate 31 is designed in trapezoidal form having the lower end as the bottom side. This agrees well with the form defined by the guide grooves 38 and 38.

On each of the substrate guides 35 at left and right, a guide groove 45 is formed, and a guide groove 46 to face to the guide groove 45 is formed on the trunk 36. A plane defined by the guide groove 45 and the guide groove 46 is inclined at an angle about 60° with respect to the circuit substrate 31 and these grooves are arranged at symmetrical positions at left and right. Groove width of each of the guide grooves 45 and 46 is maintained at the same value from the upper end to the lower end. A distance “b” between groove bottom of the guide grove 45 and groove bottom of the guide groove 46 is increased in a downward direction.

The photodetection sensor substrate 33 is inserted between the guide groove 45 and the guide groove 46. The photodetection sensor substrate 33 is also designed in trapezoidal form having its width decreased in an upward direction, and this agrees with the form defined by the guide groove 45 and the guide groove 46. Another substrate tip support (not shown) different from the substrate tip support 41 is provided on the ceiling 39, and this is engaged with tip of the photodetection sensor substrate 33.

On the front side of the trunk 36, there is provided a cylindrical curved surface 47 in form of a cylindrical surface or approximately cylindrical surface long in a vertical direction along the side edge (left in the figure). At the boundary between the cylindrical curved surface 47 and other portion on the front surface, a boundary groove 48 is provided to clearly define the cylindrical curved surface 47 from a flat surface.

On each end of the cylindrical curved surface 47, guide grooves 51 and 51 extending in a vertical direction are formed. Groove width of the guide grove 51 is maintained at the same value from the top to the bottom. The distance “b” between groove bottoms of the guide grooves 51 and 51 is increased from the upper end toward the lower end. The photodetection sensor substrate 33 is inserted into the guide grooves 51 and 51 from below. As described above, the photodetection sensor substrate 33 is designed in form of a trapezoid with its width reduced in an upward direction, and this agrees well with the form defined by the guide grooves 51 and 51.

A guide groove 52 is formed along one end closer to the center on the cylindrical curved surface 47, and a guide groove 53 is formed on the side of the trunk 36 at a position facing to the guide groove 52. A plane formed by the guide groove 53 and the guide groove 52 runs in parallel to the circuit substrate 31. The groove width of each of the guide grooves 52 and 53 is maintained at the same value from the top to the bottom, and a distance “c” between groove bottoms of the guide grooves 52 and 53 is increased from the upper end toward the lower end. The diode driving substrate 32 is inserted into the guide grooves 52 and 53. As described above, the diode driving substrate 32 is designed in form of a trapezoid with its width decreased in an upward direction, and this agrees with the form defined by the guide grooves 52 and 53. Although not shown in the figures, the upper end of the diode driving substrate 32 is engaged with another substrate tip support formed on the ceiling 39.

On the base 28, a substrate base end support 54 protruding upward is provided, and the substrate base end support 54 is engaged with the lower end of the circuit substrate 31. The circuit substrate 31 is supported by the substrate guides 35 and 35, the substrate tip support 41 and the substrate base end support 54 from four directions. The diode driving substrate 32 and the photodetection sensor substrate 33 are also supported in the same manner. As the photodetection sensor substrate 33 has narrow width, the photodetection sensor substrate 33 has sufficiently high support strength even if it is not supported by the substrate tip support and the substrate base end support.

Each of the substrates 31, 32 and 33 is designed in such structure that it is directly supported on the case 29 without requiring mounting members separately furnished. Further, because each of the substrates 31, 32 and 33 is designed in form of a trapezoid, these substrates are easily mounted or removed and can be simply inserted when assembling. This extremely simplifies the assembling procedure.

On the diode driving substrate 32, nine light emitting diodes 21 are provided —3 diodes at the middle in a horizontal direction, 3 diodes in V-shaped arrangement on upper side and 3 diodes in inverted V-shaped arrangement on lower side —9 diodes in total. Each of these light emitting diodes 21 flashes on and off with a pattern corresponding to a photodetecting position of the photodetection device 27.

The three photodetection sensor substrates 33 as described above are arranged in such manner that these are deviated in direction each at an angle of 120°. Each of the photodetection sensor substrates 33 can receive and detect light within the range of at least 120° in a horizontal direction. By these three photodetection sensor substrates 33, a laser beam 4 coming from all horizontal directions within 360° can be received and detected. Because the cylindrical curved surface 47 is curved, even when the laser beam 4 is irradiated at an angle toward the photodetection sensor substrate 33 on the front side, there is less reflection at the cylindrical curved surface 47, and the laser beam 4 effectively enters the photodetection elements 25.

As many photodetection elements 25 as required are arranged in a vertical direction on the photodetection sensor substrate 33. By identifying from a photodetection signal as to on which photodetection sensor substrate 33 and at which position on the photodetection sensor substrate 33 the photodetection element 25 currently receiving the light is positioned, it is possible to detect the photodetecting position on the photodetection device 27.

The result of photodetection from the photodetection device 27 is sent to the control unit of the bulldozer 2 via the connector 34 for external connection.

A display unit 56 and an operation unit 57 are provided on the front side of the case 29 by attaching panels and sheets or by coating. Except the diode portion, the display unit 56 is designed in non-transparent so that the flashing status of the light emitting diodes 21 can be clearly identified. On the operation unit 57, switch can be turned on and off, etc. by the photodetection device 27 only. On the base 28, the battery 30 can be easily replaced.

In the photodetection device as described above, the trunk 36 has its diameter reduced in an upward direction and the substrate guide 35 has its diameter reduced in a downward direction. The distances between the guide grooves 38 and 38, between the guide grooves 45 and 46, between the guide grooves 51 and 51, and between the guide grooves 52 and 53 are increased in a downward direction respectively. Such shapes provides drafts when the case 29 is integrally molded. In particular, the distances between the guide grooves 38 and 38, between the guide grooves 45 and 46, between the guide grooves 51 and 51, and between the guide grooves 52 and 53 are increased in a downward direction, providing adequate drafts. As a result, groove width can be maintained at the same value from the upper end toward the lower end. When substrates such as the circuit substrate 31 are inserted into the guide grooves, there is no possibility to cause backlash.

Further, the case 29 has its upper end closed, and this provides sufficient strength. The substrate guide 35 integrally molded serves as a rib member, and the boundary groove 48 contributes to higher cross-sectional strength. Further, the circuit substrate 31, the diode driving substrate 32, and the photodetection sensor substrate 33 are provided so as to run across the trunk 36, and a part of the trunk 36 and these substrates form a closed cross-section together. By mounting these substrates, rigidity and strength can be increased, and these substrates themselves serve as reinforcing members. By synergistic effects caused by configurational effects of the case 29 and the reinforcing effects of the substrates, etc., a structure in lightweight design and having high strength and high rigidity can be provided.

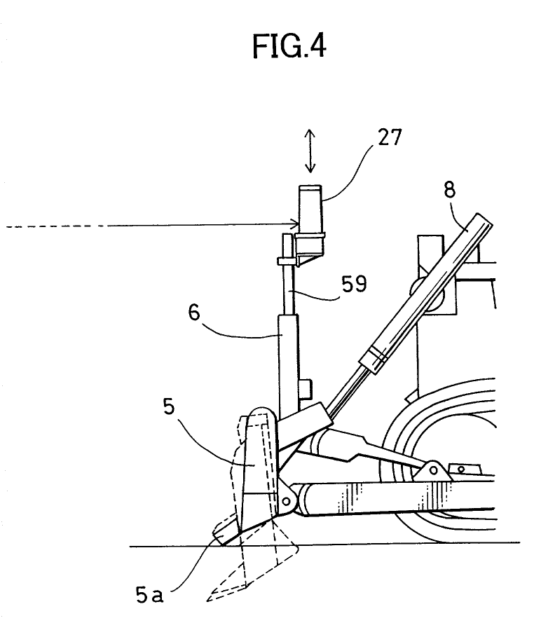

FIG. 4 shows the photodetection device 27 of the present invention when it is mounted on the pole 6.

The pole 6 has a drive unit such as motor and a lift mechanism such as screw, nut, etc. incorporated in it, and the pole 6 can move a rod 59 up and down. The photodetection device 27 is mounted on upper end of the rod 59.

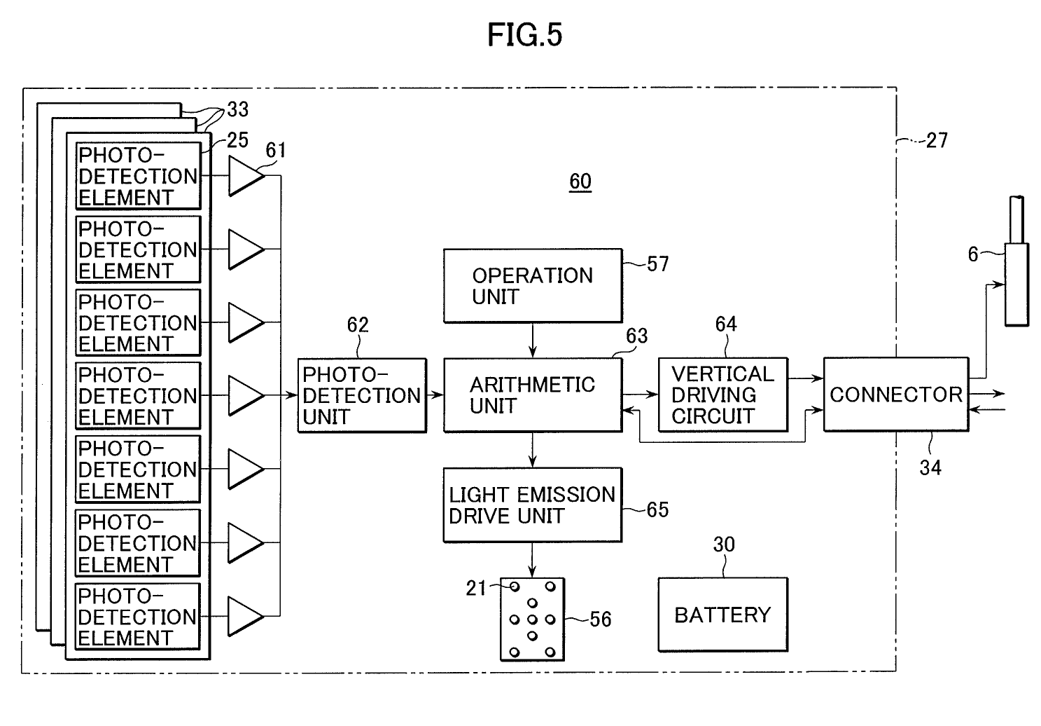

As shown in FIG. 5, the photodetection device 27 comprises a control circuit 60, and it has a control function to detect a photodetecting position of the laser beam 4 and to output a driving signal for driving the pole 6 and also has a communicating function to output the detection result to the control unit of the bulldozer 2 and to receive a signal from the control unit of the bulldozer 2. Description will be given now on general features of the control circuit 60.

The photodetection element 25 is connected to a photodetection unit 62 via an amplifier circuit 61, and a signal from the photodetection unit 62 is outputted to an arithmetic unit 63. The operation unit 57 and the display unit 56 are connected to the arithmetic unit 63.

From the arithmetic unit 63, a driving command to move the pole 6 up and down is outputted to a vertical driving circuit 64. From the vertical driving circuit 64, a driving signal is outputted to the pole 6 via the connector 34 for external connection. A photodetection signal of the photodetection device 27 is outputted to the control unit of the bulldozer 2 via the connector 34 for external connection. From the control unit, a vertical position command for the pole 6 is inputted via the connector 34 for external connection. Further, from the arithmetic unit 63, a driving signal for flashing the light emitting diodes 21 corresponding to the photodetecting position is issued to a light emission drive unit 65.

Now, description will be given below on operation.

When the laser beam 4 is projected to the photodetection device 27, one of the three photodetection sensor substrates 33 receives and detects the laser beam 4, and the photodetection signal is issued from the photodetection element 25, which receives the light. The photodetection signal is amplified at the amplifier circuit 61 and is inputted to the photodetection unit 62.

The photodetection unit 62 detects as to which photodetection element 25 has received the laser beam 4, and the result of detection is inputted to the arithmetic unit 63. Based on the input result, the arithmetic unit 63 judges whether the photodetecting position is higher or lower compared with a reference photodetecting position. Based on the result of the judgment, the pattern of flashing of the light emitting diodes 21 is judged. Then, the light emission driving signal is issued to the light emission drive unit 65, and the light emission drive unit 65 flashes the light emitting diodes 21 in the pattern required.

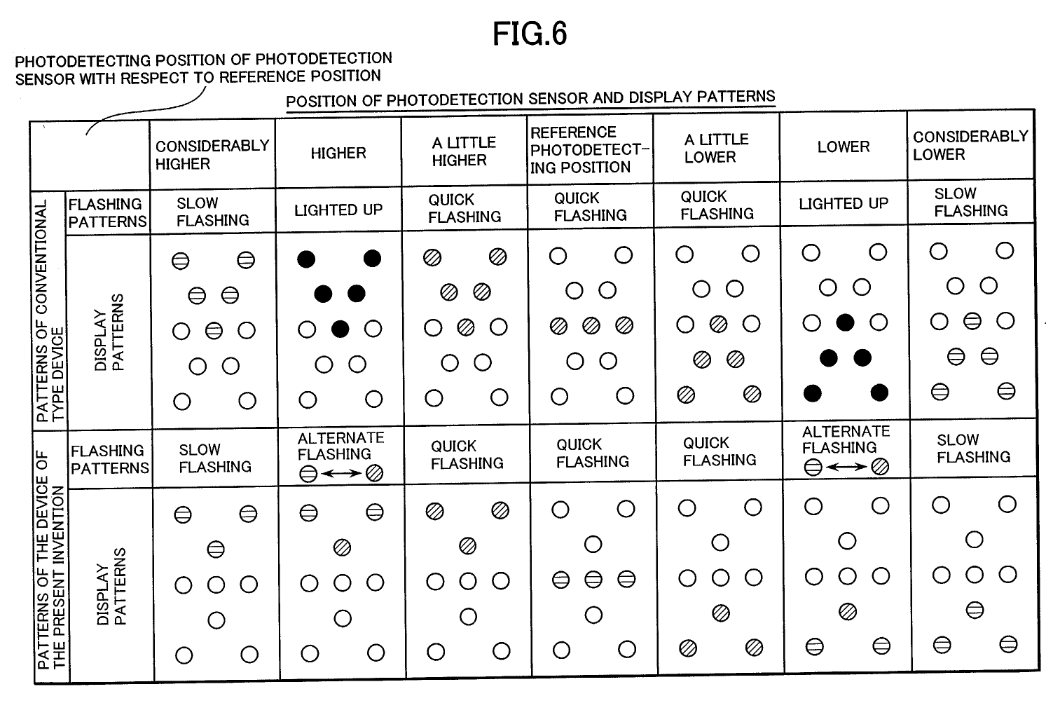

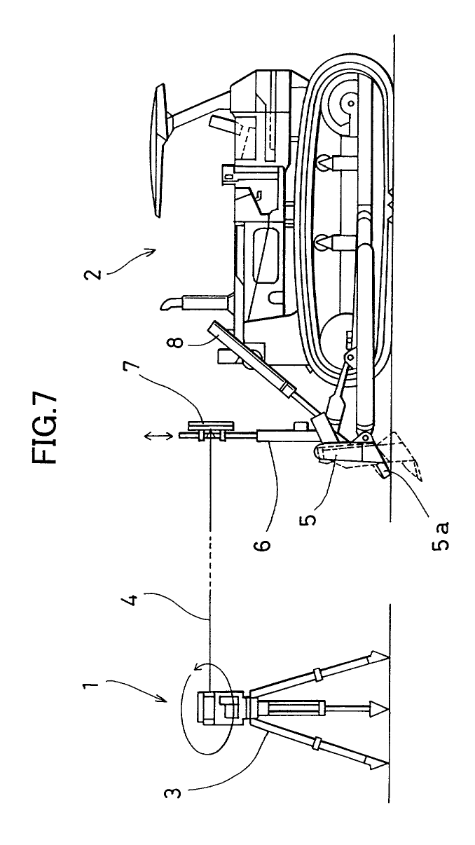

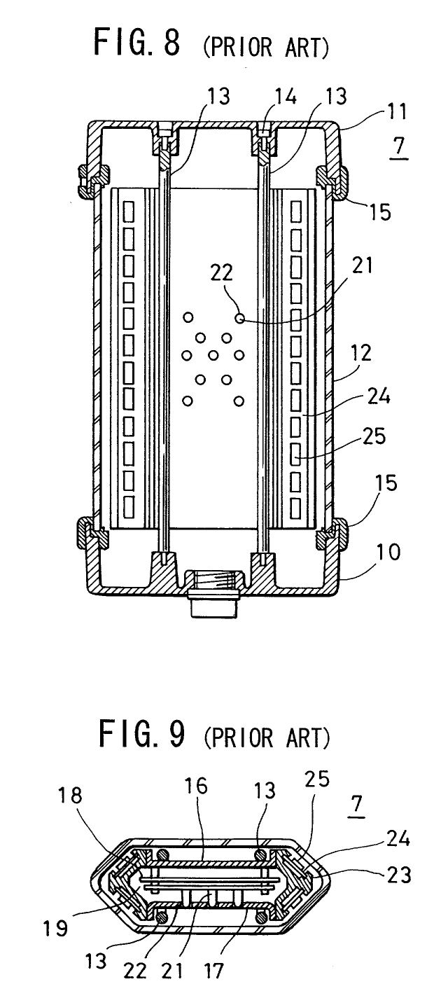

Display patterns are shown in FIG. 6. The display patterns shown in the lower column are the display patterns of the present embodiment.

In case the photodetecting position of the photodetection device 27 is considerably higher compared with the reference photodetecting position, the upper three light emitting diodes 21 in smaller V-shaped arrangement begin to flash slowly. In case it is higher, among the upper three light emitting diodes 21 in smaller V-shaped arrangement, the upper two diodes and the lower one diode begin to flash alternately. Further, in case it is a little higher compared with the reference photodetecting position, the upper three light emitting diodes 21 in smaller V-shaped arrangement begin to flash quickly. In case the photodetecting position is aligned with the reference photodetecting position, the three light emitting diodes 21 at a horizontal position begin to flash quickly.

In case the photodetecting position of the photodetection device 27 is a little lower compared with the reference photodetecting position, the lower three light emitting diodes 21 in smaller inverted V-shaped arrangement begin to flash quickly. In case it is lower, among the lower three light emitting diodes 21 in smaller inverted V-shaped arrangement, the upper one diode and the lower two diodes begin to flash alternately. Further, in case it is considerably lower compared with the reference photodetecting position, the lower three light emitting diodes 21 in smaller inverted V-shaped arrangement begin to flash slowly.

By watching the flashing pattern of the light emitting diodes 21, an operator can judge whether the current digging level of the bulldozer 2 is higher or lower compared with the reference position.

In the present embodiment, the number of the flashing light emitting diodes 21 is three at the highest, and power consumption is low.

Next, description will be given on a case where ground leveling work is adjusted to a constant level.

In case the photodetecting position of the photodetection device 27 is deviated from the reference photodetecting position, a direction and an amount of deviation are detected by the photodetection unit 62 from the photodetecting status of the photodetection elements 25, and the result of detection is outputted to the arithmetic unit 63.

The arithmetic unit 63 outputs the detection result to the control unit (not shown) of the bulldozer 2 via the connector 34 for external connection. At the control unit, based on the outputted signal, the hydraulic cylinder 8 is driven and controlled so that the photodetecting position of the photodetection device 27 is aligned with the reference photodetecting position.

Next, in case the level of the ground leveling operation is changed, the height position change command for the photodetection device 27 is outputted from the control unit of the bulldozer 2 to the photodetection unit 27 via the connector 34 for external connection.

At the arithmetic unit 63, based on the position change command, the pole 6 is driven via the vertical driving circuit 64. For instance, the pole 6 adjusts the position of the photodetection device 27 to a higher position, and the photodetecting position of the photodetection device 27 is turned to lower than the reference photodetecting position.

The photodetection unit 62 detects the photodetecting position, and the arithmetic unit 63 is operated in such manner that the lower three light emitting diodes 21 in smaller inverted V-shaped arrangement begin to flash corresponding to the photodetection status. The photodetection status is outputted to the control unit of the bulldozer 2 via the arithmetic unit 63. The control unit drives the hydraulic cylinder 8, and the position of the blade 5 is adjusted in such manner that the photodetecting position is aligned with the reference photodetecting position.

While watching the display pattern on the display unit 56, the operator may operate the hydraulic cylinder 8 so that the three light emitting diodes 21 at the middle in a horizontal position begin to flash.

According to the present invention, the photodetection device for accommodating photodetection elements and for detecting a photodetecting position comprises a base, a transparent cylindrical case fixed on the base and having a closed upper end, guide grooves formed with the case, and substrates with electronic components, wherein the substrates are engaged and held in the guide grooves. As a result, the device is in lightweight design and has high strength. There is no need to have other components to support the substrates, and the assembling procedure is easy to perform.

A distance between groove bottoms of the guide grooves facing to each other and holding the substrates is increased from an upper end toward a lower end. This serves as draft when withdrawing from the molding die, and groove width can be maintained at the same constant value. This makes it possible to hold the substrates without causing backlash.

The substrates has its diameter reduced toward an upper end of the substrate. This facilitates insertion and withdrawal of the substrates and contributes to the higher assembling workability.

The substrate is provided in such manner that a closed cross-section is formed by the substrate and the case. This contributes to the attainment of higher rigidity and strength.

The substrate is a photodetection sensor substrate where photodetection elements are arranged in a linear direction, three photodetection sensor substrates are arranged in three different directions, and a portion of the case facing to at least one of the photodetection sensor substrates is curved in form of a cylindrical surface. This makes it possible to receive and detect the light in wide range of a smaller number of the photodetection sensor substrates.

As many light emitting elements as required are arranged on the substrates, and status of photodetecting position is displayed in a combination of flashing light emission and alternate light emission depending on the photodetecting position. As a result, diverse modes of display can be provided using a smaller number of light emitting elements. This contributes to the operation of the device at lower power consumption.

What is claimed is:

1. A photodetection device for accommodating photodetection elements and for detecting a photodetecting position, comprising a base, a transparent cylindrical case fixed on said base and having a closed upper end, guide grooves formed with said case, and substrates with electronic components, wherein said substrates are engaged and held in said guide grooves.

2. A photodetection device according to claim 1, wherein a distance between groove bottoms of said guide grooves facing to each other and holding said substrates is increased from an upper end toward a lower end.

3. A photodetection device according to claim 2, wherein the distance between said groove bottoms of said guide grooves for holding said substrates are widened in form of a trapezoid from the upper end toward the lower end, and a distance of draft of a molding die is reduced when the molding die is withdrawn from the lower end.

4. A photodetection device according to claim 1, wherein a support to engage with a tip of said substrate is provided at a ceiling of said case, a support to engage with a base end of said substrate is provided on said base, and said substrate is held by said ceiling and said base.

5. A photodetection device according to claim 1, wherein said substrate has its diameter reduced toward an upper end of said substrate.

6. A photodetection device according to claim 1, wherein said substrate is provided in such manner that a closed cross-section is formed by the substrate and the case.

7. A photodetection device according to claim 1, wherein said substrate is a photodetection sensor substrate where photodetection elements are arranged in a linear direction, three photodetection sensor substrates are arranged in three different directions, and a portion of said case facing to at least one of said photodetection sensor substrates is curved in form of a cylindrical surface.

8. A photodetection device according to claim 7, wherein said photodetection device further comprises a light emitting element substrate where the light emitting elements are arranged, said case is designed in cylindrical shape with an approximately rectangular cross-section, said photodetection sensor substrates are arranged at three corners of said case, and said light emitting element substrate is provided in parallel to one surface of said case including a remaining corner.

9. A photodetection device according to claim 1, wherein as many light emitting elements as required are arranged on said substrates, and status of photodetecting position is displayed in a combination of flashing light emission and alternate light emission depending on the photodetecting position.
